(19) United States
(12) Patent Application Publication
(10) Pub. No.: US 2008/0159191 A1
(43) Pub. Date: Jul. 3, 2008

(54) WIRELESS COMMUNICATION AND DISPLAY SYSTEM AND METHOD

(75) Inventors: Chien-Hsiung Wang, Taipei City (TW); Shi-Feng Hsu, Hsinchu City (TW); C.H. Huang, Taichung County (TW); Yu-Mei Cheng, Taoyuan County (TW); Shing-Bih Chen, Yuanli Town (TW)

Correspondence Address: Akin Gump LLP - Silicon Valley, 3000 El Camino Real, Two Palo Alto Square, Suite 400, Palo Alto, CA, 94306, US

(73) Assignee: INDUSTRIAL TECHNOLOGY RESEARCH INSTITUTE, Chu Tung (TW)

(21) Appl. No.: 11/766,100

(22) Filed: Jun. 20, 2007

Related U.S. Application Data
(60) Provisional application No. 60/878,604, filed on Jan. 3, 2007.

(51) Int. Cl. H04B 7/00; H04B 1/38

(52) U.S. Cl. 370/310; 455/517; 455/566

(57) ABSTRACT

A wireless communication method for information display devices is provided. The wireless communication method includes identifying a base station capable of transmitting display information directed to a first information display device and display information directed to a second information display device, identifying the information display devices capable of communicating with the base station, identifying a first group of at least one information display device capable of receiving the display information directed to the first information display device and the display information directed to the second information display device, identifying a second group of at least one information display device capable of receiving the display information directed to the second information display device through the first information display device, receiving from the base station the display information directed to the first and second information display device, and forwarding from the first information display device to the second information display device the display information directed to the second information display device. A wireless communication system for information display devices, an information display device, a system for communicating with information display devices and a method for providing wireless communications are also provided.

### RELATED APPLICATION

The application claims priority provisional application from provisional application No. 60/878,604 entitled “WIRELESS COMMUNICATION AND DISPLAY SYSTEM AND METHOD,” which was filed on Jan. 3, 2007.

### BACKGROUND OF THE INVENTION

The invention relates generally to wireless communication and display systems and methods, and more particularly, relates to information displays capable of communicating wirelessly and the method of such communication.

A communication network, such as a wireless communication network allows the devices within the network to transmit or receive data within the network. Devices in a network may provide one or more functions, such as storing, receiving, and/or displaying data. In the example of a wireless network, the devices within the network may rely on wireless communications using infrared (IR) or radio frequency (RF) signals to transmit and receive data. However, a wireless communication station has limits in its coverage due to the limitation on signal strength and power and the fact the signal strength decays over distance. As the distance between a transmitter and a receiver increases, the strength of the signal received and the transmission quality decrease. Additionally, signal quality and coverage may be affected by factors such as physical barrier, signal interferences, weather and transmission conditions and formats, etc. Therefore, coverage gaps may exist in certain areas, resulting limited or no network access.

Taking the application of wireless networks to an electronic shelf label (ESL) system as an example, suppliers of the system developed solutions to reduce coverage gaps and ensure correct data transmission. One example of the solutions is to provide more base stations to fill the coverage gaps. However, system cost increases as the number of stations increases. Another example of the solutions is to rely on repeaters, extenders or multiplexers to extend the signal coverage. For example, multiplexing antennae may be adopted to provide better coverage. However, in some applications, having additional antennae may again increase the system cost. In some applications, it also may present additional issues due to impedance mismatch.

### BRIEF SUMMARY OF THE INVENTION

Examples of the invention may provide a wireless communication method for information display devices. The method includes identifying a base station capable of transmitting display information directed to a first information display device and display information directed to a second information display device. The information display devices capable of communicating with the base station may also be identified. The method also includes identifying a first group of at least one information display device capable of receiving the display information directed to the first information display device and the display information directed to the second information display device, the first information display device being in the first group, and identifying a second group of at least one information display device capable of receiving the display information directed to the second information display device through the first information display device, the second information display device being in the second group. The first information display device receives from the base station the display information directed to the first information display device and the display information directed to the second information display device. The first information display device then forwards to the second information display device the display information directed to the second information display device.

Examples of the invention may provide a wireless communication system. The system includes information display devices capable of communicating with a base station that is capable of transmitting display information directed to a first information display device and display information directed to a second information display device, wherein the information display devices comprise a first group of at least one information display device capable of receiving the display information directed to the first information display device and the display information directed to the second information display device, the first information display device being in the first group, and a second group of at least one information display device capable of receiving the display information directed to the second information display device through the first information display device, the second information display being in the second group. And the first information display device is capable of forwarding to the second information display device the display information directed to the second information display device.

Examples of the invention may further provide a wireless communication system for information display devices. The system includes at least one of the information display devices having an input interface configured for receiving display information from a base station, and a transceiver interface configured for communicating with the base station and adjacent information display devices, wherein the information display devices comprise a first information display device capable of receiving display information directed to the first and second information display devices from the base station, a second information display device capable of receiving the display information directed to the second information display device through the first information display device, wherein the first information display device is capable of forwarding to the second information display device the display information directed to the second information display device.

Examples of the invention may provide an information display device that includes an input interface configured to receive display information directed to the information display device and a second information display device from a base station, and to receive information from the second information display device. The information display device also includes a processing device coupled to the input interface and configured to locate and identify the second information display device. And the information display device includes an output interface coupled to the input interface and the processing device and configured to forward the display information directed to the second information display device, and to forward the information from second the information display device to the base station.

Examples of the present invention may provide a system for communicating with information display devices. The system includes a processing device configured to provide a request for locating and identifying a first information display device capable of receiving display information directed to the first information display device and directed to a second information display device, and a communication interface coupled with the processing device and configured to transmit to the first information display device the display information directed to the first information display device and to transmit to the second information display device through the first information display device the display information directed to the second information display device.

Examples of the invention may also a method for providing wireless communications. The method includes identifying a first information display device capable of receiving information directed to the first information display device and information directed to a second information display device, identifying the second information display device capable of receiving through the first information display device the information directed to the second information display device, receiving from a base station and by the first information display device the information directed to the first information display device and the information directed to the second information display device, and forwarding from the first information display device to the second information display device the display information directed to the second information display device.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a flow chart illustrating a wireless communication method for information display devices in accordance with one example of the invention;

FIG. 2 is a flow chart illustrating a method for providing wireless communications in accordance with another example of the invention;

FIG. 3 is a block diagram illustrating an information display device in accordance with one example of the invention;

FIG. 4 is a schematic diagram illustrating a base station in accordance with one example of the invention;

FIG. 5a is a schematic diagram illustrating a wireless network architecture in accordance with still another example of the invention;

FIG. 5b is a schematic diagram illustrating a wireless network architecture in accordance with one other example of the invention;

FIG. 5c is a schematic diagram illustrating a wireless network architecture in accordance with a further example of the invention;

FIG. 5d is a schematic diagram illustrating a wireless network architecture in accordance with yet another example of the invention; and

FIG. 6 is a schematic diagram illustrating a wireless network system applicable to electronic shelf labels (ESLs) in accordance with one specific example of the invention.

### DETAILED DESCRIPTION OF THE INVENTION

Reference will now be made in detail to the present embodiments of the invention, examples of which are illustrated in the accompanying drawings. Wherever possible, the same reference numbers will be used throughout the drawings to refer to the same or like parts.

Examples of the invention may provide wireless communication and display systems and methods. In some examples, a wireless communication system may adopt a multi-hop architecture which includes one or more information display devices capable of forwarding display information and/or acknowledging the receipt of the display information directed to the information display devices. In some examples, the system may include a base station capable of transmitting the display information directed to first and second information display devices. The information display devices are capable of communicating with the base station. In particular, the information display devices include a first group of at least one information display device capable of receiving the display information directed to the first and second information display device. The information display devices also include a second group of at least one information display device capable of receiving the display information directed to the second information display device through the first information display device.

In other words, the first information display device may receive the display information that is directed to the second information device but which could not be received directly by the second information device due to limited signal strength, coverage or setting by network. Certain mechanisms may be employed to confirm the receipt of information by one or more of the devices. In one example, the first information display device may be capable of acknowledging a receipt to the base station of the display information that is directed to the second information display device. The second information display device may also be capable of acknowledging a receipt to the first information display device of the display information directed to the second information display device.

According to the some examples of the invention, the base station may include a gateway device which identifies with or connects to the information display devices using an identifier, such as a unique ID (identification code) in the wireless communication system. An example of the unique ID associated with a base station or information display devices may include a set of numbers that can be transmitted as a part of display information, header of the information packet, control packet or sensing data so as to enable the information display devices to acknowledge their corresponding information packets from the base station or other information display devices, and vice versa.

For example, as the base station transmits via the gateway device the display information directed to the first and second information display devices, the gateway device may identify the first information display device, which may acknowledge the receipt of the display information directed to the first information display device. Also, the first information display device may receive display information directed to the second information display device. Next, the gateway device may request the first information display device to locate and identify other information display devices that can be reached through the first information display device. For example, the first information display device may locate and identify the second information display device, which may acknowledge the receipt of the display information directed to the second information display device. Accordingly, the display information directed to the second information display device may be forwarded through the first information display device to the second information display device.

Generally, communication systems may use multi-hop techniques, which may involve transmitting and forwarding the display information from a base station to a plurality of information display devices. In one example, some or all of the information display devices not only may have a display function for displaying the display information, but also may provide a hop function. The hop function allows the display information to be received and transmitted by the information display devices with one hop or multiple hops. In some examples, an information display device may provide, in addition to its display function, a transmission management function or a controller which manages or controls the receipt and transmission of display information.

In examples consistent with the invention, the information display devices may incorporate additional functions or components for other applications. For example, the information display device may include sensing devices and/or controller devices or an interface configured to communicate with sensing devices and/or controller devices. In one example, the sensing device may provide information about the conditions surrounding an information display device, such as temperature, lighting, humidity, location, or real-time video or audio. And signals or signal packages containing information associated with those conditions may be relayed or routed to a base station or other devices through the information display device. It is noted that the information display devices discussed above are merely illustrative, and a system may have many information display devices in addition to the first and second ones or in addition to those in the first and second groups of information display devices. And the information display devices may be configured to have the same or different functions. For example, in a system with two or more devices or groups, the gateway device may further request the second information display device to locate and identify the group of information display devices that cannot be reached by the first and second hops. For example, the second information display device may search for a third information display device that acknowledges the receipt of the display information directed to the third information display device through the first and second information display devices. And the first information display device may forward the display information directed to the third information display device to the second information display device, which in turns may forward to the third information display device the display information directed to the third information display device.

Other examples of the invention may provide the wireless communication system for information display devices having display information transmitted thought a wireless network, such as wireless personal area network (WPAN), wireless local area network (LAN) or wireless web area network (WAN), depending on the coverage area of the wireless network. One example consistent with the invention may rely on a WPAN based on IEEE 802.15.4 combined with ZigBee standard.

Reference will now be made in detail to the present embodiments of the invention, examples of which are illustrated in the accompanying drawings. Wherever possible, the same reference numbers will be used throughout the drawings to refer to the same or like parts.

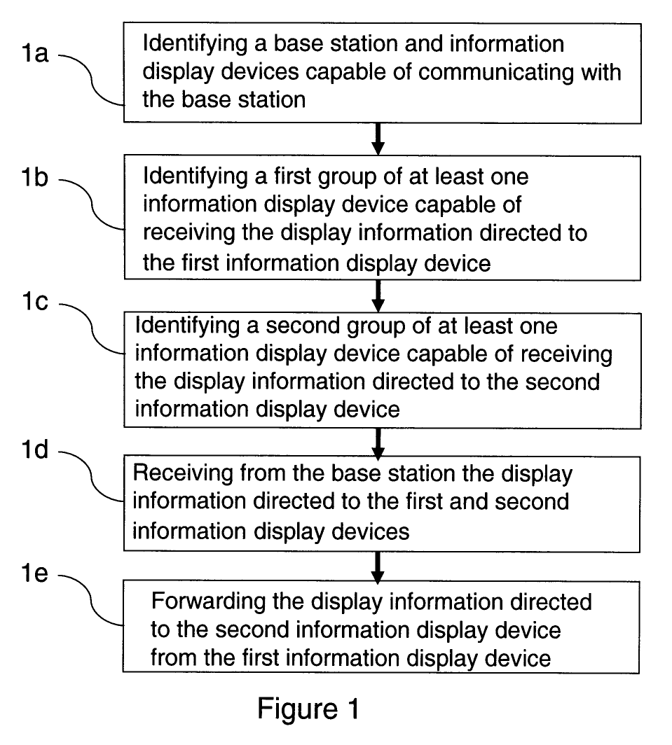

Examples consistent with the invention may also provide a wireless communication method for information display devices. Referring to FIG. 1 for a wireless communication method for information display devices in accordance with one example of the invention. In the wireless communication method of the invention, a base station and information display devices capable of communicating with the base station may be identified according to step 1a. The base station may include a system server connected to a gateway device using the unique ID described above. The gateway device may be provided for transmitting display information directed to display devices, such as a first information display device and a second information display device in one example. Those information display devices are capable of communicating with the base station or the gateway device. In one example, the information display devices may have two or more groups. In step 1b, a first group of at least one information display device capable of receiving the display information directed to the first information display device or other devices in the group may be identified. In addition, the first group of information display devices is capable of receiving the display information directed to other devices outside the first group, such as the second information display device or devices in the second group of information display devices. In step 1c, a second group of at least one information display device capable of receiving the display information directed to the second information display device through the first information display device may also be identified. The method then proceeds to step 1d.

In step 1d, the display information directed to the first and second information display devices may be received from the base station. In one example, the first information display device in the first group may receive the display information directed to the first information display device from the gateway device. The first information display device may also receive the display information directed to the second information display device from the gateway device, so that the display information directed to the second information display device may be forwarded from the first information display device in accordance with step le.

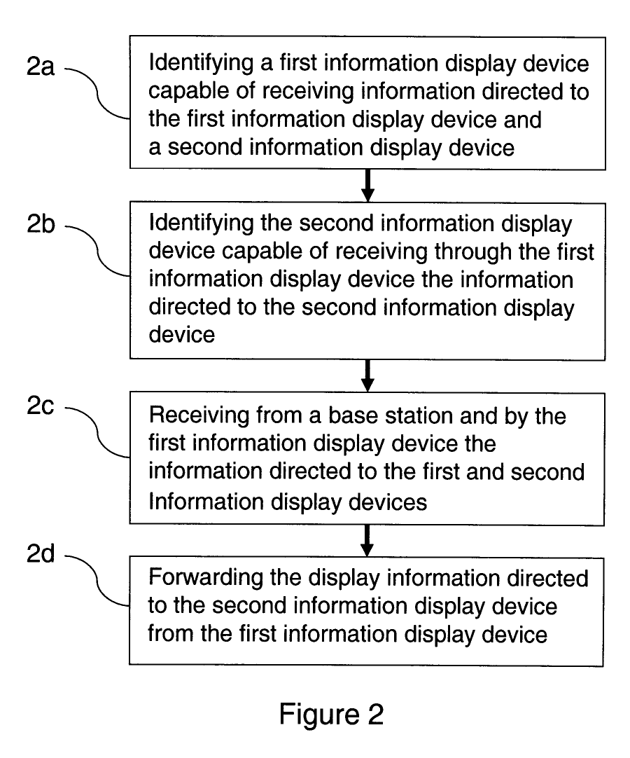

Referring to FIG. 2 for a method of providing wireless communications in accordance with another example of the invention. In step 2a, a first information display device capable of receiving information directed to the first information display device and information directed to a second information display device is identified. In step 2b, the second information display device capable of receiving through the first information display device the information directed to the second information display device is identified. The method then proceeds to step 2c. In step 2c, the first information display device may receive the display information directed to the first and second information display devices from the base station. The first information display device may acknowledge a receipt of the display information that is directed to the first information display device. The method proceeds to step 2d. In step 2d, the display information directed to the second information display device is forwarded from the first information display device to the second information display device. And the second information display device may acknowledge a receipt of the display information that is directed to second information display device through the first information display device.

Other examples of the invention may also provide an information display device which includes an input interface configured to receive display information directed to the information display device and a second information display device from the base station and to receive information from the second information display device; a processing device coupled to the input interface and configured to locate and identify the second information display device; and an output interface coupled to the input interface and the processing device and configured to forward the display information directed to the second information display device, and to forward the information from the second information display device to the base station.

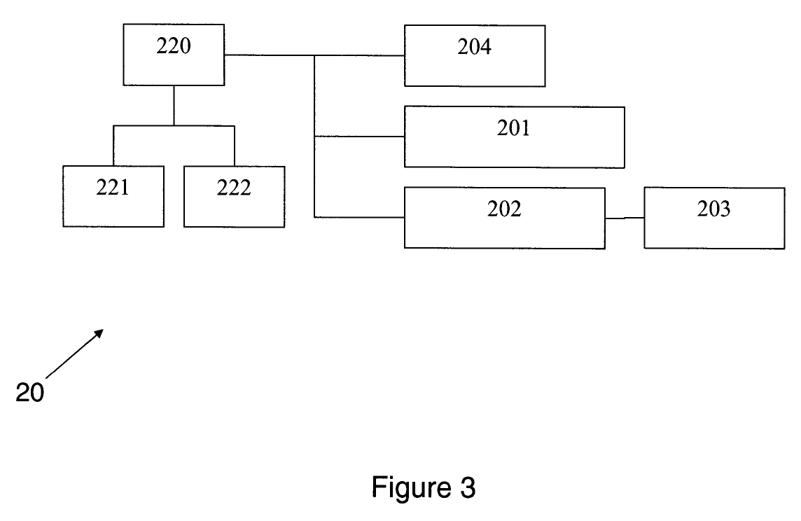

According to one example illustrated in FIG. 3, the information display device 20 may include a general purpose input/output (GPIO) interface 201 to acquire the surrounding information. For example, the GPIO interface 201 may be coupled to a sensor, push button, switch or electrical device to monitor or control the information directed to the information display device 20. The GPIO interface is also coupled to a processing device, such as a microcontroller unit (MCU) 220 coupled to a flash memory 221 and a random access memory (RAM) 222 to locate and identify the information display device at the next hop. The information display device 20 may include a radio frequency (RF) transceiver 202 coupled to the GPIO interface 201. The RF transceiver 202 is also coupled to an antenna 203 to relay the display information to other information display devices at the next hop. For example, the RF transceiver 202 may forward via the antenna 203 the display information directed to the second information display device. In addition, the information display device 20 may include a display module 204 such as a segment type display, a dot matrix type display or a combination of both for displaying at least a part of the information directed to the information display device 20.

Examples consistent with the invention also provide a base station or system for communicating with information display devices. The system includes a processing device configured to provide a request for locating and identifying a first information display device capable of receiving display information directed to the first information display device and directed to a second information display device; and a communication interface coupled with the processing device and configured to transmit to the first information display device the display information directed to the first information display device and to transmit to the second information display device through the first information display device the display information directed to the second information display device. In accordance with examples of the invention, the processing device may be a workstation, database, system server or computer which coordinates with the communicating interface to manage transmission of display information to the information display devices. For example, the communicating interface may also be a gateway or gateway device coupled wirelessly or with wired cable to the processing device. In other examples, the communicating interface may also be integrated or built in as a chipset or communicating component in the processing device. Therefore, a workstation configured to provide a communication function may identify the information display devices and transmit the display information directed to the information display devices without having the gateway or gateway device coupled to the workstation.

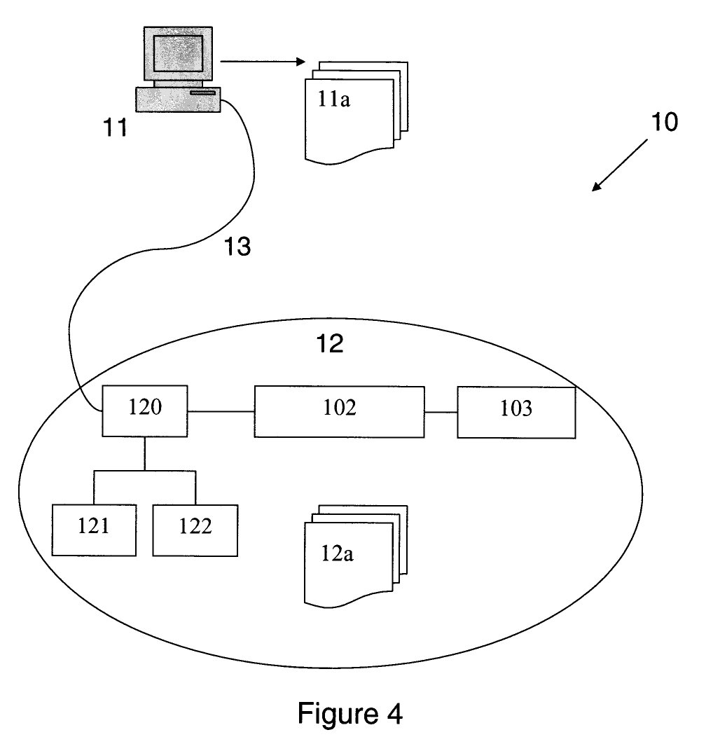

According to one example of the invention illustrated in FIG. 4, the base station 10 may include a workstation 11 and a gateway 12 coupled via a wire cable 13 to the workstation 11. For example, the workstation 11 may be connected to the gateway 12 by using a local area network (LAN) cable, universal serial bus (USB) cable, IEEE 1394 interface, RS232 interface or RS485 interface. The gateway 12 may include a MCU 120, flash memory 121 and RAM 122. The MCU 120 is also coupled to a RF transceiver 102, which in turn is connected to an antenna 103 to relay the display information to the information display devices. For example, the RF transceiver 102 may transmit through the antenna 103 the display information directed to the information display devices at different hop levels. As examples of the invention, the workstation 11 may be installed with software 11a such as gateway interface API, information display device management program and web access control management program for directing the managing the transmission of display information between the workstation 11, the gateway 12 and the information display devices. However, the software 11a used should not be limited to those types described above. Other software applications or tools known to those skilled in the art for controlling the data transmission and identifying the information display devices may also fall within the scope of the present invention. In accordance with certain examples of the invention, the gateway 12 may also include firmware 12a for identifying and locating the information display devices, and coordinating the data transmission between the gateway 12, the workstation 11 and the information display devices. For example, the firmware 12a may be configured to provide at least host interface function, transmitting status check function and alive check function.

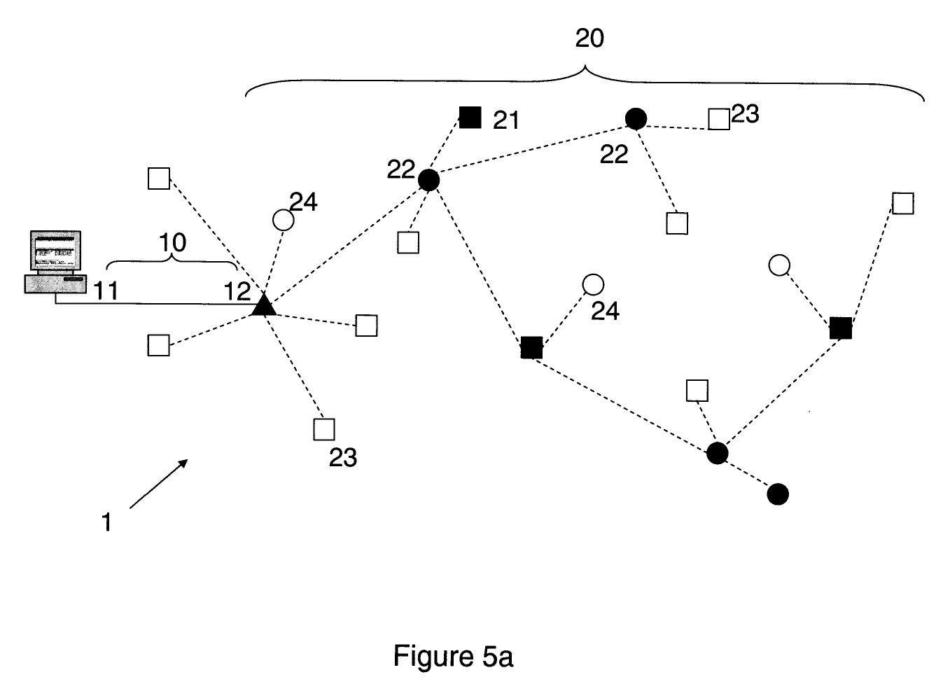

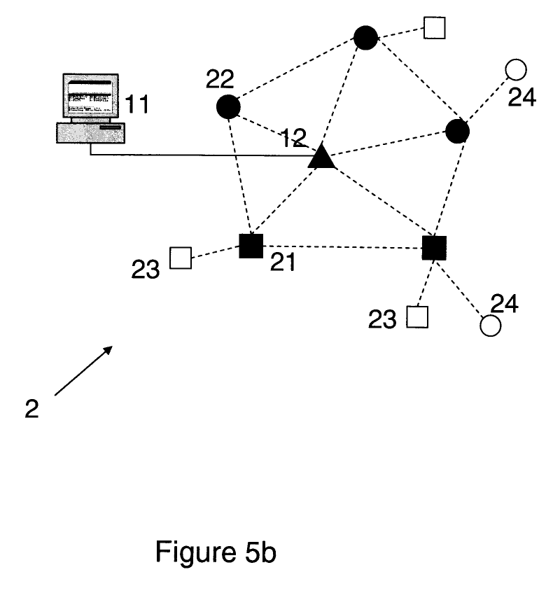

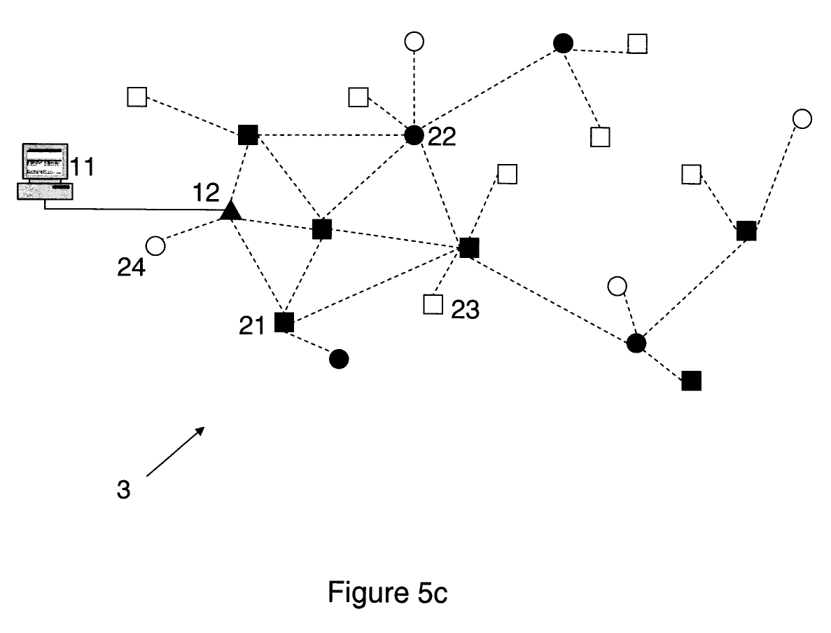

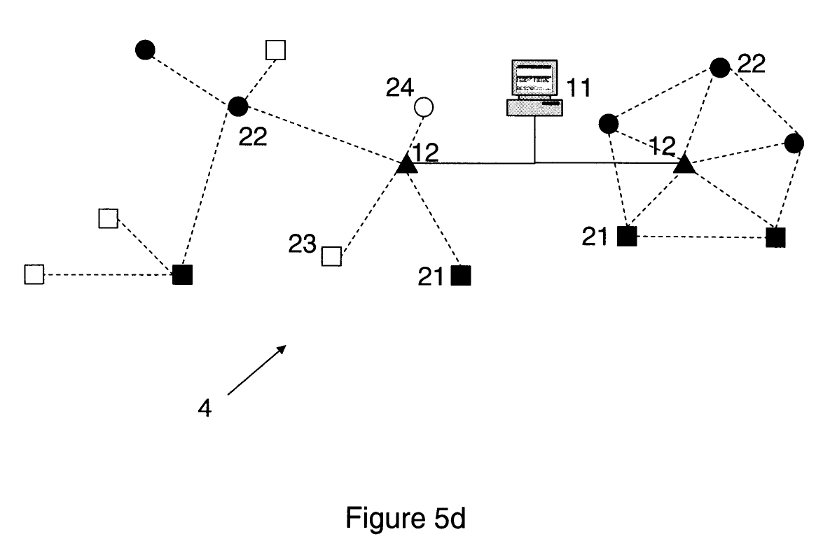

In some examples consistent with the invention, the information display devices and the base station may be arranged in a variety of wireless networks or network architectures. FIGS. 5a through 5d illustrate examples of wireless network architectures that may be used in some examples, but other architectures may be used or combined without being limited to those illustrated here.

FIG. 5a illustrates an example of a wireless network architecture. Referring to FIG. 5a, the base station 10 and a plurality of information display devices 20 may be arranged in a cluster tree network 1, with groups or clusters of the information display devices 20 constructed in branches and connected to the base station 10. In one example, the base station 10 may include a system server 11 and a gateway device 12, such as a personal area network (PAN) gateway device, coupled to the system server 11 via wireless or wired communication such as LAN cable, universal serial bus USB cable, IEEE 1394 interface, RS232 interface, RS485 interface, and so on. The PAN gateway device 12 may transmit, and in some cases, translate and transmit, the display information in a packet format between the system server 11 and the information display devices 20. Therefore, the system server 11 may send out the display information through the PAN gateway device 12 to the information display devices 20. Also, the system server 11 may be remotely accessed by a terminal or handheld device using the wireless or wired communication such as LAN cable or RS485 interface. And the access to the system server 11 may require identifying verification for the purpose of securing data in the system server 11.

Referring to FIG. 5a, the information display devices 20 may include first relay nodes 21 having a display module to display the information content and a processing module having built-in firmware or instructions. As an example, an information display device 20 may include a GPIO interface to acquire the surrounding information and a RF transceiver to relay the display information to the information display devices at the next hop. The information display devices 20 may also include second relay nodes 22 having a processing module to relay display information to the next hop. The information display devices 20 may further include first end nodes 23 having the display module and a GPIO interface to respond to an incoming message by acknowledging the receipt of the display information or to send certain sensing information through themselves or other information display devices 20 to the PAN gateway device 12 or system server 11.

In some examples, the information display devices 20 may include second end nodes 24 having the GPIO interface to respond to an incoming message by acknowledging the receipt of the display information or to send certain sensing information to the PAN gateway device 12 or system server 11. The display module may include a segment type display, a dot matrix type display or a combination of both. Moreover, the GPIO interface may be coupled to a sensor, push button, switch and a combination thereof for the operation of the interface or device.

According to the cluster tree network 1 illustrated in FIG. 5a, the information display devices 20 at the first hop may include the second relay nodes 22 and the first and second end nodes 23 and 24 in communication with the system server 11 via the gateway device 12. The second relay nodes 22 at the first hop may be arranged to communicate with the first and second relay nodes 21 and 22 and the first end nodes 23 at the second hop. The first and second relay nodes 21 and 22 at the second hop may in turn communicate with the second relay nodes 22 and first end nodes 23 at the third hop. And the second relay nodes 22 at the third hop may be further arranged to communicate with the first and second relay nodes 21 and 22 and the first end nodes 23 at the fourth hop. In addition, the first relay nodes 21 at the fourth hop may be arranged to communicate with the first and second end nodes 23 and 24 at the fifth hop.

FIG. 5b illustrates another example of a wireless network system architecture. Referring to FIG. 5b, the base station 10 and a plurality of information display devices 20 may be arranged in a mesh or peer-to-peer network 2, where the information display devices 20 may communicate with each other to provide one or more communication paths through the network. According to the mesh network 2 illustrated in FIG. 5b, the information display devices 20 at the first hop may include the first and second relay nodes 21 and 22 in communication with each other and with the system server 11 via the gateway device 12. The first and second relay nodes 21 and 22 at the first hop may then be arranged to communicate with the first and second end nodes 23 and 24 at the second hop.

FIG. 5c illustrates a further example of a wireless network architecture. Referring to FIG. 5c, the base station 10 and the plurality of information display devices 20 may be arranged in a combination of the cluster tree and mesh networks 3, with groups or clusters of the information display devices 20 further branched out from the information display devices 20 in the mesh network. According to the combination of the cluster tree and mesh networks 3 illustrated in FIG. 5c, the information display devices 20 at the first hop may include the first relay nodes 21 and the second end nodes 24 in communication with the system server 11 via the gateway device 12. The first relay nodes 21 at the first hop may be arranged to communicate with each other and with the first and second relay nodes 21 and 22, and the first end nodes 23 at the second hop. The first and second relay nodes 21 and 22 at the second hop may be further arranged to communicate with the second relay nodes 22, the first and second end nodes 23 and 24 at the third hop. In addition, the second relay nodes 22 at the third hop may in turn be arranged to communicate with other information display devices 20 at the fourth or even the fifth hop, wherein these information display devices 20 include but are not limited to the first relay nodes 21 and the first and second end nodes 23 and 24.

FIG. 5d illustrates yet another example of a wireless network architecture. Referring to FIG. 5d, the base station 10 having a plurality of PAN gateway devices 12 and the corresponding information display devices 20 may be arranged in a multi-PAN network 4 around the system server 11, with groups or clusters of the information display devices 20 branched out from each of the PAN gateway devices 12. According to the multi-PAN network 4 illustrated in FIG. 5d, the information display devices 20 at the first hop may include the first and second relay nodes 21 and 22 in communication with each other and with the system server 11 via one gateway 12. The information display devices 20 at the first hop may also include the first and second relay nodes 21 and 22, and the first and second end nodes 23 and 24 in communication with the system server 11 via another gateway device 12. The second relay nodes 22 at the first hop may then be arranged to communicate with the first and second relay nodes 21 and 22, and the first end nodes 23 at the second hop. Also, the first relay nodes 21 at the second hop may be arranged to communicate with the first end nodes 23 at the third hop.

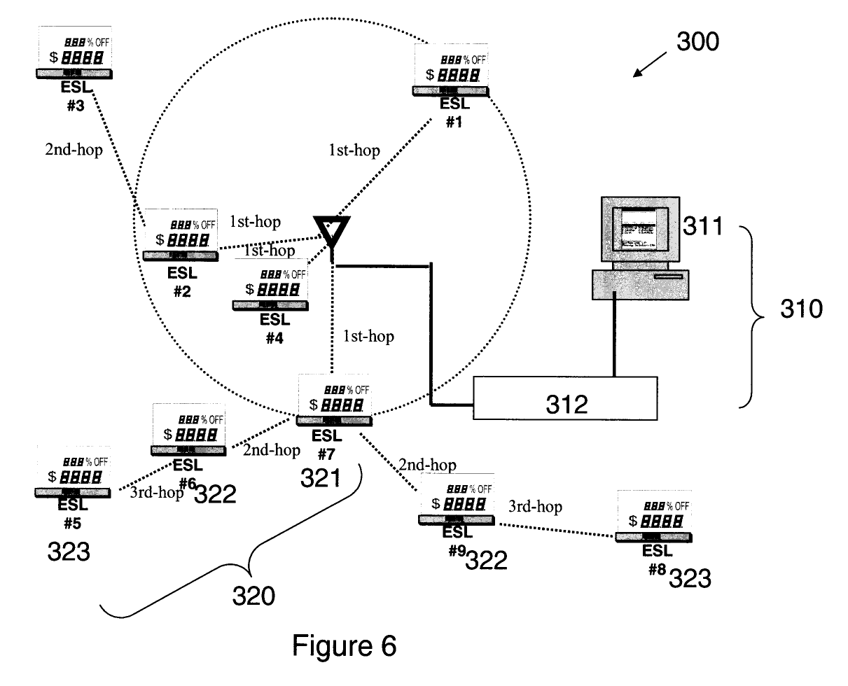

FIG. 6 illustrates an example of a wireless network system 300 applicable to transmit the display information to information display devices, such as electronic shelf labels (ESLs) 320. Referring to FIG. 6, the wireless network system 300 may include a base station 310, which may be a computer database 311 containing display information or updated display information to be displayed on the ESLs 320. The base station 310 may include a gateway device 312, such as WPAN gateway device coupled to the computer database 311, for managing the wireless communication with the ESLs 320. The gateway device 312 may provides a request for locating and identifying the ESLs 320 reachable via or in the first hop. In the illustrated example, because ESL #1, ESL #2, ESL #4 and ESL #7 have acknowledged or responded to receipt of the display information from the gateway device 312, the display information is transmitted wireless via antenna on the WPAN gateway device 312 to the ESLs at the first hop level 321. The ESLs at the first hop level 321 may then search for and identify other ESLs 320 reachable by the ESL #1, ESL #2, ESL #4 and ESL #7. Referring to FIG. 6, ESL #3, ESL #6 and ESL #9 may be reached via or in the second hop by the ESL #2 and ESL #7, respectively. In this example, the ESL #3, ESL #6 and ESL #9 have acknowledged or responded to receipt of the display information from the ESLs at the first hop level 321. Thereafter, the display information is forwarded to the ESLs at the second hop level 322. Moreover, the ESLs at the second hop level 322 may locate and identify other ESLs 320 reachable by the ESL #3, ESL #6 and ESL #9. As shown in FIG. 6, the ESL #5 and ESL #8 may be reached via or in the third hop by the ESL #6 and ESL #9, respectively. Therefore, the ESL #5 and ESL #8 may acknowledge or respond to the display information received from the ESLs at the second hop level 322. Accordingly, the display information may be further forwarded to the ESLs at the third hop level 323.

As one example of the wireless network system 300, the gateway device 312 may request the ESLs at the first hop 321 to identify other ESLs 320 that can not be reached by the first hop. The ESLs 320 may call each other and identify the ESL(s) 320 that responds sooner to the search request. The ESLs 320 may also report to the gateway device 312 that certain ESLs 320 may be reachable by the first level or first hop ESLs 321. For example, ESL #4 and ESL #7 may identify ESLs 320 under their control when it is desired for the gateway device 312 to transmit display information to the ESL #5. In this case, the ESL #7 may identify ESL #5 as an ESL 320 under its control and transmits the display information to ESL #5 via the ESL #6. And ESL #5 may respond to the gateway device 312 through ESL#6 and #7 regarding the display information ESL#5 received. Therefore, by adopting the multi-hop architecture for the wireless network system 300, the signal interference associated with wireless transmission between different levels may be resolved accordingly.

The ESLs 320 at different levels are also capable of forwarding display information back to the base station 310, where the display information may be updated or modified according to the need. In certain applications of the invention, the wireless network system 300 may be efficiently used in updating the price and item information of ESLs 320 present on the shelves at the onset of the sales period. According to some examples of the invention, each ESL 320 or base station 310 may be powered a battery or other available power supplies, such as power outlets. In other examples of the invention, some of the ESLs 320 that provide frequent relaying of signals or packets to other ESLs 320 may consume more power than others. Thus, these ESLs 320 may be powered by a permanent power supply. For example, the ESLs 320 at the branching point of the cluster tree network may be powered by a power outlet.

In addition, a sensor network may be further built upon the multi-hop concept. As one example of the invention, each of the ESLs 320 may be equipped with sensors for sensing parameters which include but not limited to temperatures, pressures, humidity, etc. of the environment surrounding the ESLs 320. The parameters acquired by the sensors are then transmitted or forwarded to the gateway device 312 by the multi-hop wireless communication as described above. The parameters may then feed into the database or analyzer to provide real time monitoring function to the supermarket or store inventory personnel. In some examples, the sensor network may also be applicable to other surveillance or control systems.

It is noted that the examples of the invention are not limited to ESLs. For example, the invention may also be applicable to other information display devices, such as electronic bulletin boards, outdoor advertisement display panels, and other information display devices. As an example, the electronic bulletin boards or outdoor advertisement display panels may transmit, forward and/or broadcast the updated text messages or display information using the multi-hop techniques.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A wireless communication method for information display devices, the method comprising:
identifying a base station capable of transmitting display information directed to a first information display device and display information directed to a second information display device;
identifying the information display devices capable of communicating with the base station;
identifying a first group of at least one information display device capable of receiving the display information directed to the first information display device and the display information directed to the second information display device, the first information display device being in the first group;
identifying a second group of at least one information display device capable of receiving the display information directed to the second information display device through the first information display device, the second information display device being in the second group;
receiving from the base station the display information directed to the first information display device;
receiving from the base station the display information directed to the second information display device; and
forwarding from the first information display device to the second information display device the display information directed to the second information display device.

2. The method according to claim 1, wherein the first information display device is capable of acknowledging a receipt to the base station of the display information directed to the second information display device.

3. The method according to claim 1, wherein the second information display device is capable of acknowledging a receipt to the first information display device of the display information directed to the second information display device.

4. The method according to claim 1, wherein the base station and the information display devices are arranged in a network including at least one of a cluster tree network, a mesh network, a combination of the cluster tree and mesh networks and a multi-PAN network.

5. The method according to claim 1, wherein the base station comprises a gateway device.

6. The method according to the claim 5, wherein the base station further comprises a system server coupled to the gateway device.

7. The method according to claim 1, wherein the information display devices comprises an interface configured to provide at least one of a sensor, push button and switch.

8. The method according to claim 1, wherein at least one of the information display devices comprises a display module.

9. The method according to claim 8, wherein the display module comprises at least one of segment type display or dot matrix type display.

10. The method according to claim 1, wherein at least one of the information display devices comprises an electronic shelf label.

11. The method according to claim 1, wherein at least one of the information display devices is capable of being equipped with at least a sensor for monitoring changes associated with the information display device.

12. A wireless communication system, the system comprising:
information display devices capable of communicating with a base station capable of transmitting display information directed to a first information display device and display information directed to a second information display device;
, wherein the information display devices comprise:
a first group of at least one information display device capable of receiving the display information directed to the first information display device and the display information directed to the second information display device, the first information display device being in the first group; and
a second group of at least one information display device capable of receiving the display information directed to the second information display device through the first information display device, the second information display being in the second group,
wherein the first information display device is capable of forwarding to the second information display device the display information directed to the second information display device.

13. The system according to claim 12, wherein the first information display device is capable of acknowledging a receipt to the base station of the display information directed to the second information display device.

14. The system according to claim 12, wherein the second information display device is capable of acknowledging a receipt to the first information display device of the display information directed the second information display device.

15. The system according to claim 12, further comprising the base station that is coupled to the information display devices through wireless communications, wherein the base station and the information display devices are arranged in a network selected from a group consisting of a cluster tree network, a mesh network, a combination of the cluster tree and mesh networks and a multi-PAN network.

16. The system according to claim 12, wherein the base station comprises a gateway device.

17. The system according to claim 16, wherein the base station further comprises a system server coupled to the gateway device.

18. The system according to claim 12, wherein the information display devices comprising an interface configured to provide at least one of a sensor, push button and switch.

19. The system according to claim 12, wherein at least one of the information display devices comprises a display module.

20. The system according to claim 19, wherein the display module comprises at least one of segment type display or dot matrix type display.

21. The system according to claim 12, wherein at least one of the information display devices comprises an electronic shelf label.

22. The system according to claim 12, wherein at least one of the information display devices is capable of being equipped with at least a sensor for monitoring changes associated with the information display device.

23. A wireless communication system for information display devices, the system comprising:
at least one of the information display devices having an input interface configured for receiving display information from a base station, and a transceiver interface configured for communicating with the base station and adjacent information display devices, wherein the information display devices comprise:
a first information display device; and
a second information display device, the first information display device capable of receiving display information directed to the first and second information display devices from the base station, the second information display device capable of receiving the display information directed to the second information display device through the first information display device;
wherein the first information display device is capable of forwarding to the second information display device the display information directed to the second information display device.

24. The system of to claim 23, wherein the first information display device is capable of acknowledging a receipt to the base station of the display information directed to the second information display device.

25. The system of claim 23, wherein the second information display device is capable of acknowledging a receipt to the first information display device of the display information directed the second information display device.

26. The system according to claim 23, wherein the information display devices further comprises an output interface for outputting the display information.

27. The system according to claim 26, wherein the output interface comprises at least one of segment type display or dot matrix type display.

28. The system according to claim 23, wherein the information display devices further comprises an interface configured to provide at least one of a sensor, push button and switch.

29. An information display device comprises:
an input interface configured to receive display information directed to the information display device and a second information display device from a base station and to receive information from the second information display device;
a processing device coupled to the input interface and configured to locate and identify the second information display device; and
an output interface coupled to the input interface and the processing device and configured to forward the display information directed to the second information display device, and to forward the information from the second information display device to the base station.

30. The information display device according to claim 29 further comprising a display module for displaying at least a part of the information directed to the information display device.

31. The information display device according to claim 29, wherein the input interface is configured to receive a request for locating and identifying an information display device capable of receiving display information directed to the second information display device.

32. A system for communicating with information display devices, the system comprises:
a processing device configured to provide a request for locating and identifying a first information display device capable of receiving display information directed to the first information display device and directed to a second information display device; and
a communication interface coupled with the processing device and configured to transmit to the first information display device the display information directed to the first information display device and to transmit to the second information display device through the first information display device the display information directed to the second information display device.

33. The system according to claim 32 further comprises a gateway device for conveying the display information between the system and the information display devices.

34. The system according to claim 32, wherein the communication interface is configured to receive information from the first information display device and information from the second information display device through the first information display device.

35. The system according to claim 34, wherein the information from the first information display device includes acknowledgement of receipt of the display information directed to the second information display device.

36. A method for providing wireless communications, the method comprising:
identifying a first information display device capable of receiving information directed to the first information display device and information directed to a second information display device;
identifying the second information display device capable of receiving through the first information display device the information directed to the second information display device;
receiving from a base station and by the first information display device the information directed to the first information display device and the information directed to the second information display device; and
forwarding from the first information display device to the second information display device the display information directed to the second information display device.

37. The method according to claim 36 further comprises:
identifying by the second information display device a third information display device capable of receiving the display information directed to the third information display device; and
forwarding by the first information display device to the second information display device the display information directed to the third information display device; and
forwarding by the second information display device to the third information display device the display information directed to the third information display device.

38. The method according to claim 37 further comprises forwarding information from the third information display device to the base station through at least one of the first information display device and the second information display device.
